(19) United States
(12) Patent Application Publication
(10) Pub. No.: US 2007/0079617 A1
(43) Pub. Date: Apr. 12, 2007

(54) Apparatus, Methods and Systems for Geothermal Vaporization of Liquefied Natural Gas

(76) Inventors: Thomas E. Farmer, Galveston, TX (US); William Merrell, Galveston, TX (US)

Correspondence Address: GORDON & JACOBSON, P.C., 60 LONG RIDGE ROAD, SUITE 407, STAMFORD, CT, 06902, US

(21) Appl. No.: 11/536,855

(22) Filed: Sep. 29, 2006

Related U.S. Application Data
(60) Provisional application No. 60/721,841, filed on Sep. 29, 2005.

(51) Int. Cl. F17C 9/02; F24J 3/08

(52) U.S. Cl. 62/50.2; 165/45

(57) ABSTRACT

Various improvements can be made to the manner in which LNG is regasified. Specifically, geothermal heat from ground water (or another geothermally-heated fluid) is extracted from a subterranean aquifer (subterranean chamber) and used as a source of heat (possibly with other heat sources) to provide efficient and effective LNG regasification with minimal environmental impact. The cool ground water (fluid) that results from LNG regasification process is returned to the subterranean aquifer (subterranean chamber), where it is heated indirectly by geothermal heat produced by the core of the earth. In the preferred embodiment, the LNG regasification process is designed such that the geothermal heat produced by the core of the earth counterbalances the heat removed from the ground water (fluid) in heating the LNG during vaporization, which avoids significant changes to the normal temperature of the ground water (fluid) held in the subterranean aquifer (subterranean chamber).

This application claims the benefit of U.S. Provisional application No. 60/721,841 filed on Sep. 29, 2005

### BACKGROUND OF THE INVENTION

1. Field of the Invention

This invention relates to apparatus, methods, and systems for regasifying liquefied natural gas, as well as cogeneration applications that utilize the energy of the liquefied natural gas to generate electric power during the regasification process.

2. State of the Art

Natural gas is typically transported from its location of production to its location of consumption by a pipeline. However, large quantities of natural gas may be produced in a country in which production far exceeds demand. Liquefaction of natural gas provides an effective way to transport the natural gas to a location where there is commercial demand.

Liquefied Natural Gas (LNG) takes up only about 1/600 of its volume in the gaseous state. LNG is produced by removing impurities from crude natural gas and then cooling the resultant natural gas below its boiling point (−259° F. at ambient pressures). LNG may be stored in cryogenic containers either at or slightly above atmospheric pressure. By heating the LNG, it may be converted back to its gaseous state.

The growing demand for natural gas has stimulated the storage and transportation of LNG by special tanker ships. Typically, the crude natural gas is gathered through one or more pipelines and supplied to a liquefaction facility that liquefies the crude natural gas into LNG. The LNG is loaded onto a tanker equipped with cryogenic compartments (such a tanker is typically referred to as an LNG carrier vessel) for overseas transport to a designated LNG Terminal. At the LNG terminal, the LNG is offloaded from the LNG carrier vessel to an LNG storage tank from which it is vaporized into its gaseous state. To regasify the LNG, the LNG is heated until it reaches its boiling point, which causes the LNG to return to its gaseous state. This natural gas is directed through a natural gas pipeline network to consumers for their energy needs (e.g., heating, cooling, cooking, energy generation, etc). The regasification of the LNG commonly uses one of three types of LNG vaporizers: an Open Rack Vaporizer, a Submerged Combustion Vaporizer, or a Shell and Tube Vaporizer.

The Open Rack Vaporizer utilizes ambient seawater as the source of heat in a fin-tube heat exchanger. The seawater is fed from an overhead distributor and flows downward over the fin-tube heat exchanger. The LNG passes through the fin-tube heat exchanger where it is heated by the ambient seawater and vaporized.

The Submerged Combustion Vaporizer utilizes a heat exchanger tube that is submerged in a water bath that is heated by a combustion burner. The LNG passes through the submerged tube where it is heated by the water bath and vaporized. Typically, the Submerged Combustion Vaporizer utilize low pressure fuel gas derived from the boil-off gases of the LNG Terminal/LNG Storage Tank and the let-down gas of the send-out gas supplied to the natural gas pipeline network.

The Shell and Tube Vaporizer employs at least two heat exchange tubes that are thermally coupled to one another. At least one of the heat exchange tubes carries a heat transfer medium, which is typically seawater or glycol water and possibly an intermediate fluid. Another heat exchange tube carries the LNG as it is regasified into natural gas. The cooled heat transfer medium output by the Shell and Tube Vaporizer may be heated (for example, by gas turbine exhaust as part of a waste heat recovery process) and returned to the Shell and Tube Vaporizer in a closed-circuit configuration.

Each of these regasification technologies has significant drawbacks. The Submerged Combustion Vaporizer has lower energy efficiency as compared to the Open Rack Vaporizer and it also produces air pollution (CO2, NOx, CO) as a byproduct of fuel combustion and thus may contribute to global warming. Shell and Tube Vaporizer's that rely on fuel combustion also have these same drawbacks. The Open Rack Vaporizer has improved energy efficiency and does not burn fossil fuels, thus avoiding the production of air pollution and any global warming effects associated therewith. However, construction of the intake and return seawater lines can cause significant impact to sensitive/protected marine environments. Moreover, during operation, the intake line removes large volumes of marine plankton and the return line discharges large volumes of cold seawater, which can impact sensitive/protected marine environments. Often, these problems lead to significant design requirements and regulatory hurdles that must be satisfied, which increase the total cost of the regasification system. The discharged seawater also typically contains residual chlorine, which results from chlorination of the intake water to combat bio-fouling of the system. Such residual chlorine can have a negative impact on the marine environment. Shell and Tube Vaporizer's that rely on seawater for heating also have these same drawbacks.

Thus, there is a need in the art for improved apparatus, methods, and systems for the regasification of LNG that provide energy efficiency and reduced air pollution (and thus reduce any global warming effects associated therewith) while avoiding environmental impact to sensitive/protected marine environments.

### SUMMARY OF THE INVENTION

It is therefore an object of the invention to provide apparatus, methods, and systems for the regasification of LNG that are energy efficient.

It is another object of the invention to provide such apparatus, methods, and systems for the regasification of LNG that reduce air pollution and thus reduce any global warming effects associated therewith.

It is a further object of the invention to provide such apparatus, methods, and systems for the regasification of LNG that avoid environmental impact to sensitive/protected marine environments.

It is also an object of the invention to provide such apparatus, methods, and systems for the regasification of LNG as part of cogeneration facility that utilizes the energy of the liquefied natural gas to generate electric power during the regasification process.

In accord with these objects, which will be discussed in detail below, apparatus, methods, and systems of the present invention utilize geothermal heat from ground water extracted from a subterranean aquifer as a source of heat (possibly with other heat sources) to provide efficient and effective LNG regasification with minimal environmental impact. The cool ground water that results from LNG regasification process is returned to the subterranean aquifer, where it is heated indirectly by geothermal heat produced by the core of the earth. Preferably, the LNG regasification process is designed such that the geothermal heat produced by the core of the earth counterbalances the heat removed from the ground water in heating the LNG, which avoids significant changes to the normal temperature of the ground water held in the subterranean aquifer.

It will be appreciated that the use of ground water as a source of heat for LNG heating provides efficient and effective LNG regasification with minimal environmental effects. Importantly, air pollution and any global warming that results therefrom can be significantly reduced. Moreover, when located near a marine/protected environment, there is minimal impact to the marine environment because the subterranean aquifer is separated therefrom by the earth's crust. Thus, the negative impacts to sensitive marine/protected environments that are experienced by seawater-based vaporizers are avoided. Moreover, when used with deep subterranean aquifers, the water extracted from the subterranean aquifer can have extremely high temperatures as compared to ambient seawater. This feature, which leverages the natural geothermal heating provided by the earth's core, provides for greater heating for a given flow rate of water and thus allows for increased capacity of LNG regasification at the given flow rate. Finally, the temperature of the water extracted from the subterranean aquifer will remain substantially constant year round. This allows for a simpler, more-efficient and less costly design as compared to the prior art open rack vaporizers and air vaporizers, which must account for significant variations in the temperature of ambient seawater and air, respectively, that naturally occurs during the year as the seasons change.

According to one embodiment of the invention, the extracted ground water is supplied to a heat exchanger that vaporizes LNG into its gaseous state for supply to a natural gas pipeline.

According to another embodiment of the invention, the extracted ground water is supplied to a heat exchanger that vaporizes LNG for fuel supply to a combustion chamber of a second heat exchanger that vaporizes LNG into its gaseous state for supply to a natural gas pipeline.

According to yet another embodiment of the invention, an LNG regasification process employing geothermal heating can readily be adapted to provide for generation of electricity.

According to yet another embodiment of the invention, a Rankine-cycle process for LNG regasification and electrical power generation is adapted to employ geothermal heating of the thermal conducting fluid that is circulated in the Rankine-cycle process.

According to another embodiment of the invention, the extracted ground water is supplied to a first heat exchanger that uses the heat contained in the extracted ground water to heat a heat transfer fluid flowing therethrough as part of a loop. The heat transfer fluid heated by the first heat exchanger is supplied to a second heat exchanger (e.g., vaporizer) that uses the heat contained in the heat transfer fluid to heat LNG preferably into its gaseous state for supply to a natural gas pipeline. The heat transfer fluid can possibly be recycled through the second heat exchanger for one or more additional LNG heating cycles. The cold of the LNG is transferred to the heat transfer fluid during this LNG heating process. The cold heat transfer fluid generated by the second heat exchanger may be used as a cold source in a refrigerant application. The heat transfer fluid is returned to the first heat exchanger for geothermal heating and the process repeats itself. The heat transfer fluid can be recycled through the first heat exchanger for one or more heat transfer fluid heating cycles.

According to another embodiment of the invention, another fluid that is stored in a subterranean chamber and heated by the core of the earth (such as oil stored in salt domes as part of the Strategic Oil Reserves of the United States of America) is extracted from the earth and used as a source of heat for LNG heating. After being cooled by LNG heating, the cooled fluid may be used as a source for cold for industrial applications and/or possibly returned back to the subterranean chamber from which it was extracted for geothermal heating.

Additional objects and advantages of the invention will become apparent to those skilled in the art upon reference to the detailed description taken in conjunction with the provided figures.

### BRIEF DESCRIPTION OF THE DRAWINGS

FIG. 1 is a schematic diagram of a first illustrative embodiment of an LNG degasification facility in accordance with the present invention.

FIG. 2 is a schematic diagram of a second illustrative embodiment of an LNG degasification facility in accordance with the present invention.

FIG. 3 is a schematic diagram of components that cooperate with the components of FIGS. 1 and 2 to provide for cogeneration of electrical power.

FIG. 4 is a schematic diagram of an embodiment of a facility that employs a Rankine-cycle process for LNG regasification and electrical power generation in accordance with the present invention.

FIG. 5 is a schematic diagram of an alternate embodiment of an LNG degasification facility in accordance with the present invention.

### DETAILED DESCRIPTION OF THE PREFERRED EMBODIMENTS

In accordance with the present invention, various improvements can be made to the manner in which LNG is regasified. Specifically, geothermal heat from ground water extracted from a subterranean aquifer can be used as a source of heat, possibly with other heat sources, to provide efficient and effective LNG regasification with minimal environmental impact. The cool ground water that results from LNG regasification process is returned to the subterranean aquifer, where it is heated indirectly by geothermal heat produced by the core of the earth. In the preferred embodiment, the LNG regasification process is designed such that the geothermal heat produced by the core of the earth counterbalances the heat removed from the ground water in heating the LNG during vaporization, which avoids significant changes to the normal temperature of the ground water held in the subterranean aquifer. As used herein, a “subterranean aquifer” or “subterranean chamber” is a source of a fluid (e.g., ground water”) that lies below the surface of the earth and is geothermally-heated by the energy released by the core of the earth. It should be noted that oceans, seas, bays, gulfs, lakes, rivers or other bodies of water may overlie all or portions of a subterranean aquifer or subterranean chamber.

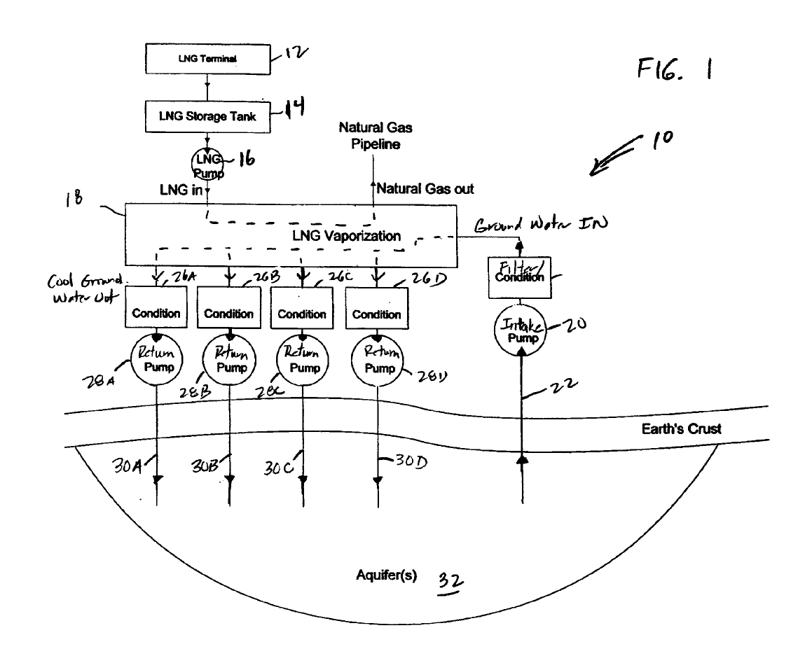

In an exemplary embodiment shown in FIG. 1, an LNG regasification facility 10 includes an LNG terminal 12 that offloads LNG from an LNG carrier vessel (not shown) to an LNG storage tank 14. A cryogenic pump 16 pumps the LNG stored in the tank to a vaporizer 18 that heats the LNG passing therethough to a temperature above its boiling point to thereby regasify the LNG into its gaseous state. The natural gas produced by the vaporizer 18 is directed to a natural gas pipeline network for supply to consumers for their energy needs.

In accordance with the present invention, geothermally-heated ground water extracted from a subterranean aquifer 32 is used as a source of heat within the vaporizer 18 for heating the LNG passing therethough. The extraction of the ground water may be provided by one or more ground water wells each having a pump and intake pipe that extends into the subterranean aquifer 32. In the example of FIG. 1, a single ground water well is shown with a pump 20 and intake pipe 22. In optional block 24, the extracted ground water may be filtered to remove sediments and possibly conditioned to remove heavy metal ions (such as Cu++ and Hg++) that can corrode the vaporizer 18. Such conditioning may include chlorination of the extracted ground water. Such chlorination may be particularly useful in locations where the ground water is brackish in nature, whereby the chlorination mitigates the corrosive nature of the brackish water. In optional blocks 26A, 26B, 26C, 26D, the cool ground water that exits the vaporizer 18 may be conditioned, for example by removing chlorine and/or other unwanted matter therefrom. The cool ground water is returned back into the subterranean aquifer 32 by one or more return wells (4 shown as return pumps 28A, 28B, 28C, 28D and corresponding return pipes 30A, 30B, 30C, 30D that extend into the subterranean aquifer 32).

In the preferred embodiment, the flow rate of ground water extracted from the subterranean aquifer 32 by the intake pump(s) is substantially equal to the flow rate of cooled ground water returned to the subterranean aquifer 32 by the return pump(s). This ensures that the water level within the subterranean aquifer 32 is not seriously affected by the operation of the facility 10. The cool ground water that is returned to the subterranean aquifer 32 is heated indirectly by geothermal heat produced by the core of the earth. In the preferred embodiment, the facility 10 is designed such that the operation of the facility 10 does not significantly alter the normal ground water temperatures within the subterranean aquifer 32. Moreover, in the preferred embodiment, the return pipe(s) is/are spaced apart from the intake pipe(s) in a configuration that ensures that the geothermal heat produced by the core of the earth counterbalances the heat removed from the ground water in heating the LNG during vaporization, which avoids significant changes to the normal temperature of the ground water held in the subterranean aquifer.

The vaporizer 18 may be a fin-tube-type heat exchanger wherein the extracted ground water is fed from an overhead distributor and flows downward over fin-tube-type heat exchange elements. The LNG passes through the fin-tube-type heat exchange elements where it is heated by the extracted ground water and vaporized. Alternatively, the vaporizer 18 may be a shell-and-tube-type heat exchanger that includes at least two heat exchange tubes that are thermally coupled to one another. One of the heat exchange tubes carries the extracted ground water. Another of the heat exchange tubes carries LNG that is heated by the extracted ground water and regasified into natural gas. The heat exchange elements of the vaporizer 18 are preferably formed from a metal with optimal heat transfer properties and with corrosion resistant properties based upon the nature of the extracted ground water. In the preferred embodiment, the heat exchange elements of the vaporizer 18 are realized from (or coated with) a corrosion resistive metal (e.g., copper-nickel alloy, copper-based metal, nickel-based metal, titanium-based metal). Such materials are particularly useful in locations with brackish ground water to mitigate the corrosive nature of the brackish ground water.

In alternate embodiments (not shown), one or more additional heat sources may be integrated as part of the vaporizer 18 (or added as part of separate yet cooperating heat exchanger(s)). For example, such additional heat source(s) may be an intermediate fluid loop heated by a combustion burner, solar power or atmospheric air. The heat provided by the additional heat source(s) may be used in conjunction with the geothermal heat provided by the ground water in order to regasify the LNG. Alternatively, the heat provided by the additional heat source(s) may be used as a substitute for the geothermal heat provided by the ground water in order to regasify the LNG, for example if the geothermal well(s) fail or a part of the geothermal heating mechanism requires maintenance.

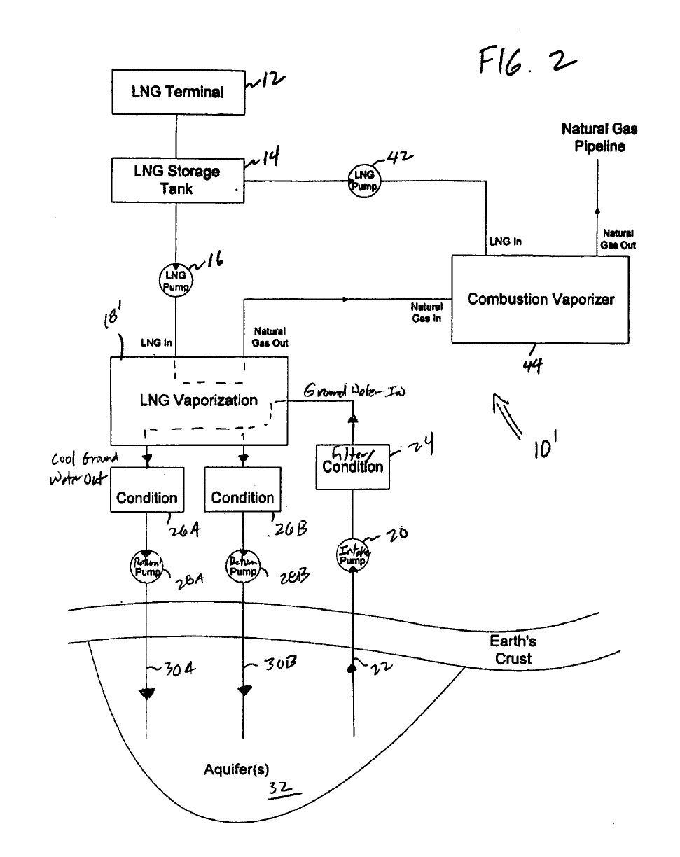

Turning now to FIG. 2, there is shown another embodiment an LNG regasification facility 10′ in accordance with the present invention, including an LNG terminal 12 that offloads LNG from an LNG carrier vessel (not shown) to an LNG storage tank 14. A first cryogenic pump 16 pumps LNG stored in the tank to a first vaporizer 18′ that heats the LNG passing therethough to a temperature above its boiling point to thereby regasify LNG into its gaseous state for use as a combustible fuel source as described below. A second cryogenic pump 42 pumps LNG stored in the tank to a combustion vaporizer 44. The first vaporizer 18′ heats the LNG passing therethough to a temperature above its boiling point to thereby regasify LNG into its gaseous state. The natural gas produced by the first vaporizer 18′ is directed to the combustion vaporizer 44 for fueling the combustion burner therein. The combustion vaporizer 44 heats the LNG passing therethough to a temperature above its boiling point to thereby regasify LNG into its gaseous state. The natural gas produced by the combustion vaporizer 44 is directed to a natural gas pipeline network for supply to consumers for their energy needs. Boil-off gas captured at the LNG Terminal 12 and/or the LNG Storage Tank 14 and possibly let-down gas captured from the send-out gas to the natural gas pipeline may be used in conjunction with (or as a substitute) for the natural gas supplied by the first vaporizer 18′.

In accordance with the present invention, geothermally-heated ground water extracted from subterranean aquifer 32 is used as a source of heat within the vaporizer 18′ for heating the LNG passing therethough. The extraction of the ground water may be provided by one or more ground water wells each having a pump and intake pipe that extends into the subterranean aquifer 30. In the example of FIG. 2, a single ground water well is shown with pump 20 and intake pipe 22. In optional block 24, the extracted ground water may be filtered to remove sediments and possibly conditioned to remove heavy metal ions (such as Cu++ and Hg++) that can corrode the vaporizer 18′. Such conditioning may include chlorination of the extracted ground water. Such chlorination may be particularly useful in locations where the ground water is brackish in nature, whereby the chlorination mitigates the corrosive nature of the brackish water. In optional blocks 26A, 26B, the cool ground water that exits the vaporizer 18′ may be conditioned, for example by removing chlorine and/or other unwanted matter therefrom. The cool ground water is returned back into the subterranean aquifer 32 by one or more return wells (2 shown as return pumps 28A, 28B and corresponding return pipes 30A, 30B that extend into the subterranean aquifer 32).

In the preferred embodiment, the flow rate of ground water extracted from the subterranean aquifer 32 by the intake pump(s) is substantially equal to the flow rate of cooled ground water returned to the subterranean aquifer 32 by the return pump(s). This ensures that the water level within the subterranean aquifer 32 is not seriously affected by the operation of the facility 10′. The cool ground water that is returned to the subterranean aquifer 32 is heated indirectly by geothermal heat produced by the core of the earth. In the preferred embodiment, the facility 10′ is designed such that the operation of the facility 10′ does not significantly alter the normal ground water temperatures within the subterranean aquifer 32. Moreover, in the preferred embodiment, the return pipe(s) is/are spaced apart from the intake pipe(s) in a configuration that ensures that the geothermal heat produced by the core of the earth counterbalances the heat removed from the ground water in heating the LNG during vaporization, which avoids significant changes to the normal temperature of the ground water held in the subterranean aquifer.

The vaporizer 18′ may be a fin-tube-type heat exchanger wherein the extracted ground water is fed from an overhead distributor and flows downward over fin-tube-type heat exchange elements. The LNG passes through the fin-tube-type heat exchange elements where it is heated by the extracted ground water and vaporized. Alternatively, the vaporizer 18′ may be a shell-and-tube-type heat exchanger that includes at least two heat exchange tubes that are thermally coupled to one another. One of the heat exchange tubes carries the extracted ground water. Another of the heat exchange tubes carries LNG that is heated by the extracted ground water and regasified into natural gas. The heat exchange elements of the vaporizer 18′ are preferably formed from a metal with optimal heat transfer properties and with corrosion resistant properties based upon the nature of the extracted ground water. In the preferred embodiment, the heat exchange elements of the vaporizer 18′ are realized from (or coated with) a corrosion resistive metal (e.g., copper-nickel alloy, copper-based metal, nickel-based metal, titanium-based metal). Such materials are particularly useful in locations with brackish ground water to mitigate the corrosive nature of the brackish ground water.

In alternate embodiments (not shown), one or more additional heat sources may be integrated as part of the vaporizer 18′ (or added as part of separate yet cooperating heat exchanger(s)). For example, such additional heat source(s) may be an intermediate fluid loop heated by solar power or atmospheric air. The heat provided by the additional heat source(s) may be used in conjunction with the geothermal heat provided by the ground water in order to regasify the LNG. Alternatively, the heat provided by the additional heat source(s) may be used as a substitute for the geothermal heat provided by the ground water in order to regasify the LNG, for example if the geothermal well(s) fail or a part of the geothermal heating mechanism requires maintenance.

The combustion vaporizer 44 is preferably realized as a submerged combustion vaporizer that includes a heat exchanger tube that is submerged in a water bath. A combustion burner heats the water bath. The LNG passes through the submerged heat exchanger tube where it is heated by the water bath and vaporized. The submerged heat exchanger tube is preferably realized from stainless steel.

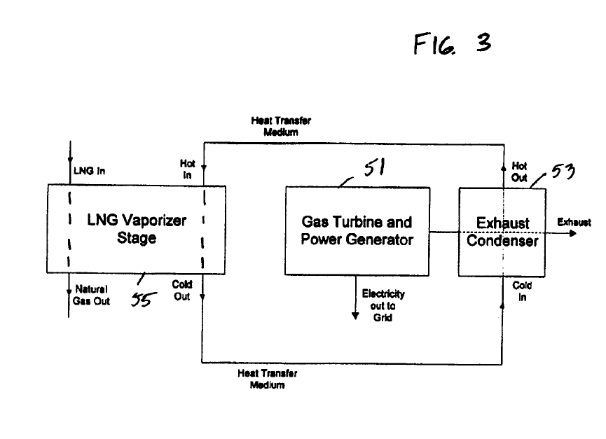

Turning now to FIG. 3, the LNG regasification facilities described herein can readily be adapted to provide for cogeneration of electricity in conjunction with the LNG regasification process. In this configuration, a natural gas turbine-based power generator 51 is used to generate electricity that is output to the electrical grid for supply to consumers for their energy needs. The hot exhaust gases from the turbine of the power generator 51 pass through a condenser 53 that transfers the heat from the exhaust gases to the heat transfer medium (e.g., water, glycol-water) of a closed circuit. The heat transfer medium is circulated through an LNG Vaporizer stage 55, which could be the geothermal LNG vaporizer 18 of FIG. 1, the geothermal LNG Vaporizer 18′ of FIG. 2, or the Combustion Vaporizer 44 of FIG. 2. The heat provided by the heat transfer medium is used by the LNG Vaporizer stage 55 to regasify the LNG.

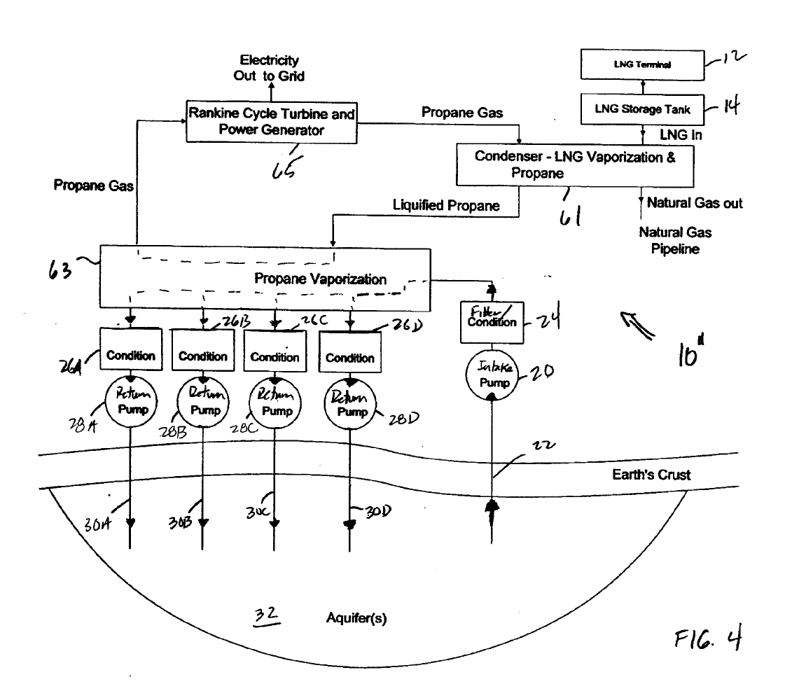

Turning now to FIG. 4, there is shown an embodiment of a facility 10″ that employs a Rankine cycle method for LNG regasification and electrical power generation. In the Rankine cycle method, a condenser 61 liquefies a low-pressure coolant gas (e.g., propane gas) by heat exchange with LNG. In this process, the pressure of the coolant is increased and the LNG is heated to a temperature above its boiling point to thereby regasify LNG into its gaseous state. The natural gas produced by the condenser 61 is directed to a natural gas pipeline network for supply to consumers for their energy needs. A vaporizer 63 heats the liquid coolant such that it becomes a high-pressure gas. This high pressure coolant gas is used to drive a turbine of a Rankine Cycle Turbine and Power generator 65, which generates electricity that is output to the electrical grid for supply to consumers for their energy needs. The low-pressure coolant gas that is exhausted from the turbine is returned to the condenser 61, where it is liquefied by heat exchange with the LNG gas. One or more pumps (not shown) may be integrated into the coolant loop as needed.

The condenser 61 is preferably a shell-and-tube-type heat exchanger that includes at least two heat exchange tubes that are thermally coupled to one another. One of the heat exchange tubes carries the coolant. Another of the heat exchange tubes carries the LNG that is heated by the coolant for regasification of the LNG.

In accordance with the present invention, geothermally-heated ground water extracted from a subterranean aquifer 32 is used as a source of heat within the vaporizer 63 for heating the coolant passing therethough. The extraction of the ground water may be provided by one or more ground water wells each including a pump and intake pipe that extends into the subterranean aquifer 32. In the example of FIG. 4, a single ground water well is shown with pump 20 and intake pipe 22. In optional block 24, the extracted ground water may be filtered to remove sediments and possibly conditioned to remove heavy metal ions (such as Cu++ and Hg++) that can corrode the vaporizer 63. Such conditioning may include chlorination of the extracted ground water. Such chlorination may be particularly useful in locations where the ground water is brackish in nature, whereby the chlorination mitigates the corrosive nature of the brackish water. In optional blocks 26A, 26B, 26C, 26D, the cool ground water that exits the vaporizer 63 may be conditioned, for example by removing chlorine and/or other unwanted matter therefrom. The cool ground water is returned back into the subterranean aquifer 32 by return wells (4 shown as pumps 28A, 28B, 28C, 28D and corresponding return pipes 30A, 30B, 30C, 30D that extend into the subterranean aquifer 32).

In the preferred embodiment, the flow rate of ground water extracted from the subterranean aquifer 32 by the intake pump(s) is substantially equal to the flow rate of cooled ground water returned to the subterranean aquifer 32 by the return pump(s). This ensures that the water level within the subterranean aquifer 32 is not seriously affected by the operation of the facility 10″. The cool ground water that is returned to the subterranean aquifer 32 is heated indirectly by geothermal heat produced by the core of the earth. In the preferred embodiment, the facility 10″ is designed such that the operation of the facility 10″ does not significantly alter the normal ground water temperatures within the subterranean aquifer 32. Moreover, in the preferred embodiment, the return pipe(s) is/are spaced apart from the intake pipe(s) in a configuration that ensures that the geothermal heat produced by the core of the earth counterbalances the heat removed from the ground water in heating the coolant during vaporization, which avoids significant changes to the normal temperature of the ground water held in the subterranean aquifer.

The vaporizer 63 may be a fin-tube-type heat exchanger wherein the extracted ground water is fed from an overhead distributor and flows downward over fin-tube-type heat exchange elements. The coolant passes through the fin-tube-type heat exchange elements where it is heated by the extracted ground water and vaporized. Alternatively, the vaporizer 63 may be a shell-and-tube-type heat exchanger that includes at least two heat exchange tubes that are thermally coupled to one another. One of the heat exchange tubes carries the extracted ground water. Another of the heat exchange tubes carries the coolant that is heated by the extracted ground water. The heat exchange elements of the vaporizer 63 are preferably formed from a metal with optimal heat transfer properties and with corrosion resistant properties based upon the nature of the extracted ground water. In the preferred embodiment, the heat exchange elements of the vaporizer 63 are realized from (or coated with) a corrosion resistive metal (e.g., copper-nickel alloy, copper-based metal, nickel-based metal, titanium-based metal). Such materials are particularly useful in locations with brackish ground water to mitigate the corrosive nature of the brackish ground water.

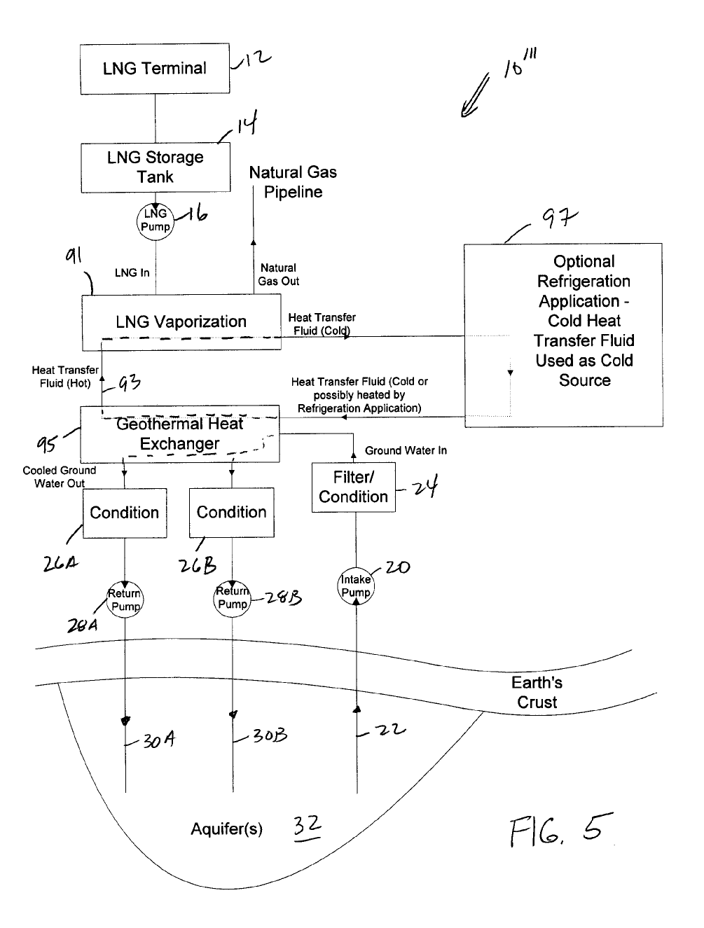

Turning now to FIG. 5, there is shown an embodiment of an LNG regasification facility 10′″ in accordance with the present invention, including an LNG terminal 12 that offloads LNG from an LNG carrier vessel (not shown) to an LNG storage tank 14. A first cryogenic pump 16 pumps LNG stored in the tank to an LNG vaporizer 91 that heats the LNG passing therethough to a temperature above its boiling point to thereby regasify LNG into its gaseous state. The natural gas produced by the LNG vaporizer 91 is directed to a natural gas pipeline network for supply to consumers for their energy needs. The LNG vaporizer 91 employs an intermediate fluid loop 93 that circulates a heat transfer fluid (e.g., water, glycol/water, DOWTHERM®) between a heat exchanger 95 and the LNG vaporizer 91. Geothermally-heated ground water extracted from a subterranean aquifer 32 is used as a source of heat within the heat exchanger 95 for heating the heat transfer fluid passing therethrough. The extraction of the ground water may be provided by one or more ground water wells each including a pump and intake pipe that extends into the subterranean aquifer 32. In the example of FIG. 5, a single ground water well is shown with pump 20 and intake pipe 22. In optional block 24, the extracted ground water may be filtered to remove sediments and possibly conditioned to remove heavy metal ions (such as Cu++ and Hg++) that can corrode the heat exchanger 95. Such conditioning may include chlorination of the extracted ground water. Such chlorination may be particularly useful in locations where the ground water is brackish in nature, whereby the chlorination mitigates the corrosive nature of the brackish water. In optional blocks 26A, 26B, the cool ground water that exits the heat exchanger 95 may be conditioned, for example by removing chlorine and/or other unwanted matter therefrom. The cool ground water is returned back into the subterranean aquifer 32 by return wells (2 shown as pumps 28A, 28B and corresponding return pipes 30A, 30B that extend into the subterranean aquifer 32).

In the preferred embodiment, the flow rate of ground water extracted from the subterranean aquifer 32 by the intake pump(s) is substantially equal to the flow rate of cooled ground water returned to the subterranean aquifer 32 by the return pump(s). This ensures that the water level within the subterranean aquifer 32 is not seriously affected by the operation of the facility 10′″. The cool ground water that is returned to the subterranean aquifer 32 is heated indirectly by geothermal heat produced by the core of the earth. In the preferred embodiment, the facility 10′″ is designed such that the operation of the facility 10′″ does not significantly alter the normal ground water temperatures within the subterranean aquifer 32. Moreover, in the preferred embodiment, the return pipe(s) is/are spaced apart from the intake pipe(s) in a configuration that ensures that the geothermal heat produced by the core of the earth counterbalances the heat removed from the ground water in heating the coolant during vaporization, which avoids significant changes to the normal temperature of the ground water held in the subterranean aquifer.

In the system of FIG. 5, the heat exchanger 95 uses the heat contained in the extracted ground water to heat the heat transfer fluid flowing therethrough as part of the loop 93. The heat transfer fluid heated by the heat exchanger 95 is supplied to LNG vaporizer 91, which uses the heat contained in the heat transfer fluid to heat LNG preferably into its gaseous state for supply to a natural gas pipeline. The heat transfer fluid can possibly be recycled through the LNG vaporizer 91 for one or more additional LNG heating cycles. The cold of the LNG is transferred to the heat transfer fluid during this LNG heating process. The cold heat transfer fluid generated by the LNG vaporizer 91 may be used as a cold source in a refrigerant application (block 97). The heat transfer fluid is returned to the heat exchanger 95 for geothermal heating and the process repeats itself. The heat transfer fluid can be recycled through the heat exchanger 95 for one or more heat transfer fluid heating cycles.

The LNG vaporizer 91 is preferably a shell-and-tube-type heat exchanger that includes at least two heat exchange tubes that are thermally coupled to one another. One of the heat exchange tubes carries the heat transfer medium. Another of the heat exchange tubes carries the LNG that is heated by the heat transfer fluid for regasification of the LNG. Alternatively, the LNG vaporizer 91 may be a fin-tube-type heat exchanger wherein the heat transfer fluid is fed from an overhead distributor and flows downward over fin-tube-type heat exchange elements. The coolant passes through the fin-tube-type heat exchange elements where it is heated by the heat transfer fluid and vaporized.

The heat exchanger 95 may be a submerged-tube-type heat exchanger wherein a tube arrangement is submerged within a bath of extracted ground water. The tube arrangement carries the heat transfer fluid. A vessel contains the bath and tube arrangement. The tube arrangement and the vessel of the heat exchanger 95 are preferably formed from a metal with optimal heat transfer properties and with corrosion resistant properties based upon the nature of the extracted ground water. In the preferred embodiment, the heat exchange elements of the heat exchanger 95 are realized from (or coated with) a corrosion resistive metal (e.g., copper-nickel alloy, copper-based metal, nickel-based metal, titanium-based metal). Such materials are particularly useful in locations with brackish ground water to mitigate the corrosive nature of the brackish ground water. Advantageously, the heat exchange elements of the LNG vaporizer 91 can be realized from a different material that need not have such high corrosion resistance due to the fact that the heat transfer fluid will typically be free from corrosives. This arrangement might possibly lower the total cost of the facility because less costly materials can be used to realize the LNG vaporizer 91.

In alternate embodiments (not shown) to those described above, one or more additional heat sources may be integrated as part of the LNG vaporizer (or added as part of separate yet cooperating heat exchanger(s)). For example, such additional heat source(s) may be an intermediate fluid loop heated by a combustion burner, solar power or atmospheric air. The heat provided by the additional heat source(s) may be used in conjunction with the geothermal heat provided by the ground water for heating purposes. Alternatively, the heat provided by the additional heat source(s) may be used as a substitute for the geothermal heat provided by the ground water (for example, if the geothermal wells fail or a part of the geothermal heating mechanism requires maintenance).

In the embodiments described herein, it is possible that the ground water/heat transfer fluid can be recycled through a respective heat exchanger of the facility one or more times for heating purposes. Note that although the ground water/heat transfer fluid will be cooled each time is thermally-contacted with the LNG, it is possible that it could be used for several cycles in heating the LNG.

In the embodiments described herein, it is also possible to heat the ground water (for example, using a solar-power heater or other cost effective heater means) after it is cooled during the LNG heating process. This hot ground water can then be used in one or more additional LNG heating cycles before it is re-injected back into the subterranean aquifer. It is also the possible that the cool ground water that is generated as a result of the LNG heating can be used in a wide variety of innovative ways. For example, the cool ground water can be used for irrigation or other purposes instead of being re-injected into the subterranean aquifer. In another example, the cool ground water can be used as a source of cold temperature for industrial applications, such as a refrigeration plant or a superconducting electrical storage ring. The ground water can be returned after it is used in a warmer state and possibly recycled through the heat exchanger for one or more additional LNG heating cycles.

In other embodiments of the invention, the LNG heating and regasification methodologies and facilities described herein can be adapted to use another geothermally-heated fluid (i.e., a fluid that is stored in a subterranean chamber and heated by the core of the earth) as substitute for, or in combination with, ground water as described above. One such fluid is oil and/or natural gas that is pumped from a subterranean reservoir. Another such fluid is oil that is pumped from a subterranean salt dome (e.g., oil is stored in such salt domes as part of the Strategic Oil Reserves of the United States of America). In this configuration, the geothermally-heated fluid is extracted from the subterranean chamber. The extracted fluid is supplied to a heat exchanger where it is used as a source of heat for LNG heating. After it is used to heat LNG, the fluid may be piped to another destination. For example, the oil and/or natural gas produced by a producing offshore platform may be used to heat LNG as part of an LNG Receiving Terminal as described herein. The LNG Receiving Terminal may be co-located with the offshore platform or may be located remotely from the offshore platform. After the geothermally-heated oil/natural gas is used to heat the LNG, it may be piped to a destination (e.g., a refinery for oil or a natural gas pipeline network for natural gas). In other configurations, after it is used to heat LNG, the geothermally-heated fluid may be used in its cooled form as a source of cold and/or returned back to its subterranean environment for geothermal heating.

Advantageously, the apparatus, systems and methods of the present invention utilize a geothermally-heated fluid (e.g., ground water extracted from a subterranean aquifer) as a source of heat (possibly with other heat sources) to provide efficient and effective LNG regasification. Importantly, air pollution and any global warming that results therefrom can be significantly reduced.

Moreover, when located near a marine/protected environment, there is minimal impact to the marine environment because the subterranean aquifer/chamber is separated therefrom by the earth's crust. Thus, the negative impacts to sensitive marine/protected environments that are experienced by seawater-based vaporizers are avoided. Moreover, when used with a deep subterranean aquifer/chamber, the geothermally-heated water/fluid extracted from the subterranean aquifer/chamber can have extremely high temperatures as compared to ambient seawater. This feature, which leverages the natural geothermal heating of the earth's core, provides for greater heating for a given flow rate of water and thus allows for increased capacity of LNG regasification at the given flow rate.

Finally, the temperature of the geothermally-heated water/fluid extracted from the subterranean aquifer/chamber will remain substantially constant year round. This allows for a simpler, more-efficient and less costly design as compared to the prior art open rack vaporizers and air vaporizers, which must account for significant variations in the temperature of ambient seawater and air, respectively, that naturally occurs during the year as the seasons change.

There have been described and illustrated herein several embodiments of apparatus, systems and methods that utilize ground water and/or another geothermally-heated fluid that is extracted from a subterranean aquifer/chamber as a source of heat (possibly with other heat sources) to provide efficient and effective LNG regasification. While particular embodiments of the invention have been described, it is not intended that the invention be limited thereto, as it is intended that the invention be as broad in scope as the art will allow and that the specification be read likewise. Thus, while particular types of heat exchangers have been disclosed, it will be appreciated that other types can be used as well. In addition, while particular LNG heating designs and electrical cogeneration designs have been disclosed, it will be understood that other such designs can be used. Moreover, while particular configurations have been disclosed in reference to the well(s) that extract ground water/another fluid from a geothermally-heated subterranean aquifer/chamber and return water back to the subterranean aquifer/chamber, it will be appreciated that other configurations could be used as well. It is also contemplated that the LNG regasification facilities described herein can readily be adapted to separate out commercially-marketable compounds from the ground water. Such compounds can include one or more specific elements such as gold, silver, magnesium, manganese, mercury, lead, uranium, and platinum and/or any other commercially-marketable element or compound that are extracted from the ground water or other geothermally-heated fluid. Such compound(s) (or material(s) derived therefrom) can be collected and sold for commercial value. In another application, carbon dioxide emissions can be captured and separated, and the carbon dioxide can be injected into the subterranean aquifer (or other subterranean source of geothermally-heated fluid) for sequestration therein. The injection of the carbon dioxide can be carried out in conjunction with the return of fluid to the subterranean source, or possibly can be carried out in an independent manner. The carbon dioxide is preferably injected more than 800 meters below the Earth's surface for safe, long-term storage. At this depth, the carbon dioxide becomes a supercritical fluid, in which it is neither liquid nor gas. Supercritical carbon dioxide is more dense than carbon dioxide gas and thus requires less storage volume. Supercritical carbon dioxide is also less mobile and has a higher solubility underground, which would make the sequestration more effective. Once injected, some of the carbon dioxide dissolves into natural gas or oil or becomes trapped in tiny rock pores. It will therefore be appreciated by those skilled in the art that yet other modifications could be made to the provided invention without deviating from its spirit and scope as claimed.

What is claimed is:

1. An apparatus for heating liquefied natural gas supplied from a liquefied natural gas source, the apparatus comprising:
supply means for extracting a geothermally-heated fluid from a subterranean source; and
a heat exchanger, fluidly coupled to said supply means and the liquefied natural gas source, that heats liquefied natural gas supplied thereto with said geothermally-heated fluid.

2. An apparatus according to claim 1, further comprising:
return means, fluidly coupled to said heat exchanger, for returning said geothermally-heated fluid back to the subterranean source.

3. An apparatus according to claim 2, wherein:
the geothermally-heated fluid comprises ground water stored in a subterranean aquifer.

4. An apparatus according to claim 2, wherein:
the geothermally-heated fluid comprises oil stored in a subterranean salt dome.

5. An apparatus according to claim 1, wherein:
the geothermally-heated fluid comprises oil pumped from a well-bore.

6. An apparatus according to claim 2, wherein:
said supply means comprises at least one intake pump fluidly coupled to at least one intake pipe that extends into the subterranean source, said at least one intake pump and said at least one intake pipe for pumping the geothermally-heated fluid from the subterranean source for supply to said heat exchanger; and
said return means comprises at least one return pump fluidly coupled to at least one return pipe that extends into the subterranean source, said at least one return pump and said at least one return pipe for pumping the geothermally-heated fluid back into the subterranean source.

7. An apparatus according to claim 1, wherein said heat exchanger comprises one of:
a fin-tube-type heat exchanger, wherein the geothermally-heated fluid is fed from an overhead distributor and flows downward over fin-tube-type heat exchange elements, and wherein liquefied natural gas passes through the fin-tube-type heat exchange elements where it is heated by the geothermally-heated fluid; and
a shell-and-tube-type heat exchanger that includes at least two heat exchange tubes that are thermally coupled to one another, wherein one of the heat exchange tubes carries the geothermally-heated fluid, and wherein another of the heat exchange tubes carries liquefied natural gas that is heated by the geothermally-heated fluid.

8. An apparatus according to claim 1, wherein:
said heat exchanger comprises heat exchange elements that are realized from a corrosion-resistive metal.

9. An apparatus according to claim 8, wherein:
said corrosion-resistive metal is selected from the group including stainless steel, zinc alloy, titanium alloy, and nickel alloy.

10. An apparatus according to claim 1, further comprising:
at least one additional heat source for heating liquefied natural gas, the at least one additional heat source utilizes at least one of a combustion burner, solar power, and atmospheric air.

11. An apparatus according to claim 10, wherein:
said at least one additional heat source is integrated as part of said heat exchanger.

12. An apparatus according to claim 10, wherein:
said at least one additional heat source is part of a separate yet cooperating heat exchanger that heats the liquefied natural gas.

13. An apparatus according to claim 1, wherein:
said heat exchanger heats the liquefied natural gas over its boiling point to thereby regasify the liquefied natural gas.

14. A liquefied natural gas regasification facility comprising:
a storage tank for storing liquefied natural gas;
the apparatus of claim 1, fluidly coupled to the storage tank, to thereby heat liquefied natural gas supplied from said storage tank.

15. A liquefied natural gas regasification facility according to claim 14, further comprising:
a terminal for offloading liquefied natural gas from a carrier vessel to said storage tank.

16. A liquefied natural gas regasification facility according to claim 14, further comprising:
a pump for pumping liquefied natural gas from said storage tank to said apparatus.

17. A liquefied natural gas regasification facility according to claim 14, wherein:
said apparatus heats liquefied natural gas over its boiling point to thereby regasify the liquefied natural gas.

18. A liquefied natural gas regasification facility according to claim 17, further comprising:
means for directing natural gas produced by said apparatus to a gas pipeline network for supply to consumers.

19. A liquefied natural gas regasification facility according to claim 18, further comprising:
an electrical power generating subsystem having a natural gas burning turbine;
a second heat exchanger for heating a heat transfer medium with exhaust generated said turbine; and
means for circulating the heat transfer medium between the heat exchanger of said apparatus and said second heat exchanger.

20. A liquefied natural gas regasification facility according to claim 18, further comprising:
a second heat exchanger having a combustion burner operably coupled to the heat exchanger of said apparatus, said second heat exchanger employing said combustion burner to heat liquefied natural gas supplied from said storage tank over its boiling point to thereby regasify the liquefied natural gas, wherein said combustion burner is fueled by natural gas produced by the heat exchanger of said apparatus.

21. A liquefied natural gas regasification facility according to claim 20, further comprising:
means for directing natural gas produced by said second heat exchanger to a gas pipeline network for supply to consumers.

22. A liquefied natural gas regasification facility according to claim 21, wherein:
said second heat exchanger is a submerged combustion vaporizer.

23. A facility for regasification of liquefied natural gas comprising:
a storage tank storing liquefied natural gas;
a first heat exchanger operably coupled to said storage tank;
a second heat exchanger operably coupled to supply means for extracting a geothermally-heated fluid from a subterranean source; and
means for circulating a heat transfer medium between said first and second heat exchangers;
wherein said first heat exchanger uses the heat transfer medium supplied thereto to heat liquefied natural gas over its boiling point to regasify the liquefied natural gas, which causes the heat transfer medium to liquefy into liquid form; and
wherein said second heat exchanger uses the geothermally-heated fluid to heat the heat transfer medium for supply to the first heat exchanger.

24. A facility according to claim 23, further comprising:
return means, operably coupled to second heat exchanger, for returning the geothermally-heated fluid back to the subterranean source.

25. A facility according to claim 23, wherein the geothermally-heated fluid comprises one of:
ground water stored in a subterranean aquifer;
oil stored in a subterranean salt dome; and
oil pumped from a well-bore.

26. A facility for regasification of liquefied natural gas in conjunction with generation of electric power, the facility comprising:
a storage tank storing liquefied natural gas;
a first heat exchanger operably coupled to said storage tank;
a second heat exchanger operably coupled to supply means for supplying geothermally-heated fluid from a subterranean source and return means for returning the geothermally-heated fluid back to the subterranean source;
an electric power generating subsystem including a Rankine cycle turbine;
means for circulating a heat transfer medium in a loop from said first heat exchanger to said second heat exchanger and then to said Rankine cycle turbine and then back to said first heat exchanger;
wherein the heat transfer medium is supplied in gaseous form from said Rankine cycle turbine to said first heat exchanger;
wherein said first heat exchanger uses the heat transfer medium supplied thereto to heat liquefied natural gas over its boiling point to regasify the liquefied natural gas, which causes the heat transfer medium to liquefy into liquid form; and
wherein said second heat exchanger uses the geothermally-heated fluid to heat the heat transfer medium over its boiling point to regasify the heat transfer medium such that the heat transfer medium is supplied to the Rankine cycle turbine in gaseous form.

27. A method for heating liquefied natural gas comprising:
extracting a geothermally-heated fluid from a subterranean source; and
heating the liquefied natural gas with heat extracted from the geothermally-heated fluid.

28. A method according to claim 27, further comprising:
returning cooled geothermally-heated fluid that is produced by the heating back to the subterranean source, where it is reheated by geothermal heat produced by the core of the earth.

29. A method according to claim 27, wherein:
the geothermally-heated fluid comprises ground water held within a subterranean aquifer.

30. A method according to claim 27, wherein:
the geothermally-heated fluid comprises oil held within a subterranean salt dome.

31. A method according to claim 27, wherein:
the geothermally-heated fluid comprises oil pumped from a well-bore.

32. A method according to claim 27, further comprising:
employing at least one additional heat source for heating liquefied natural gas, wherein said at least one additional heat source utilizes at least one of a combustion burner, solar power, and atmospheric air.

33. A method according to claim 27, wherein:
the geothermally-heated fluid is used to heat liquefied natural gas over its boiling point to thereby regasify the liquefied natural gas.

34. A method according to claim 33, further comprising:
supplying the regasified natural gas to a combustion burner for fueling the combustion burner, the combustion burning providing heat for regasification of liquefied natural gas.

35. A method according to claim 33, further comprising:
directing the regasified natural gas to a natural gas pipeline for supply to consumers.

36. A method according to claim 27, wherein:
the geothermally-heated fluid is recycled for one or more LNG heating cycles before it is returned back to the subterranean source.

37. A method according to claim 27, wherein:
the cooled geothermally-heated fluid that results from at least one LNG heating cycle is heated by a heat source before it is recycled for one or more LNG heating cycles.

38. A method according to claim 27, wherein:
the cooled geothermally-heated fluid that results from at least one LNG heating cycle is used as a source of cold.

39. A method according to claim 28, further comprising:
injecting carbon dioxide into the subterranean source for sequestration therein.

40. A method according to claim 39, wherein:
the injecting of carbon dioxide is performed in conjunction with the returning of the cooled geothermally-heated fluid back to the subterranean source.
